(19) United States
(12) Patent Application Publication
(10) Pub. No.: US 2012/0018231 A1
(43) Pub. Date: Jan. 26, 2012

(54) ENERGY-RECOVERING MOTOR VEHICLE

(76) Inventor: Said Bakraoui, Cureggio (IT)

(21) Appl. No.: 13/202,511

(22) PCT Filed: Mar. 9, 2010
(86) PCT No.: PCT/IT2010/000104

§ 371 Date: Aug. 19, 2011

(30) Foreign Application Priority Data
Mar. 20, 2009 (IT) NO2009A0000002

(51) Int. Cl. B60L 9/00

(52) U.S. Cl. 180/2.1

(57) ABSTRACT

An energy-recovering motor vehicle (1) is described, equipped with at least one turbine (3; 3b) arranged inside a space (5; 5b) inside such motor vehicle (1), such space (5; 5b) communicating with the outside environment through at least one suction manifold (7; 7b) and at least one exhaust duct (9; 9b), the turbine (3; 3b) being rotated by at least one air current (11) generated by an advancement motion (A) of the motor vehicle (1) entering through the suction manifold (7; 7b) in order to touch and rotate the turbine (3; 3b) and going out through the exhaust duct (9; 9b), the turbine (3) being further connected to means (10) for converting the mechanical energy, generated by the rotation of the turbine (3; 3b), into propulsion energy of the motor vehicle (1).

The present invention refers to an energy-recovering motor vehicle.

It is now known that the continuous growth in the use of transporting motor vehicles, both for civil use and for industrial and commercial use, by the modern society, and mainly by the most advanced industrial societies, is bringing about a more and more limited availability of fossil fuels to supply such motor vehicles. Among the others, the same use of fossil fuels to follow the increased requirements of the transport sector has brought about the well known problems deriving from emissions of carbon dioxide in the atmosphere, with other gases having obnoxious effects on the climate.

In order to solve such problem, and consequently reduce the demand for electric energy, one of the solutions to be adopted is providing motor vehicles that use alternative supply sources: the art therefore has proposed, among the others, motor vehicles with electric propulsion and motor vehicles with compressed air-type aeolian propulsion.

In general, it is known how any motor vehicle upon start-up consumes energy due to its excessive weight and how such weight, when running, is transformed into kinetic energy that supports the motor vehicle itself against the aerodynamic resistance opposed by air and generated by its own motion.

In particular, it can be considered, for example, that the energy for starting up and thrusting a motor vehicle is usually equal to an engine speed included between 2000 and 2500 revolutions per minute (rpm) starting with the first gear: after a few seconds of increase of the speed, by engaging the second gear, the engine speed again reaches a value included between 2000 and 2500 rpm, and so on for further gears to be engaged, to allow accelerating the motor vehicle. It must be noted that, when the third gear is engaged, the vehicle speed is approximately equal to 60 Km/h, while the kinetic energy is about 50% of the maximum kinetic energy that the vehicle itself is able to reach.

Going on accelerating and progressively engaging higher and higher gears, the number of engine revolutions determines the thrusting energy consumption, but the thrusting energy is transformed into speed and the kinetic energy increases till it arrives around 80%: together with the increase of the kinetic energy, the air current generated by the vehicle motion also increases. Consequently, when last-but-one and last gears are engaged, the remaining thrusting energy of the vehicle is reduced to 20%: in current motor vehicles, such remaining energy is however subjected to dissipation, since there are no devices that allow recovering it and converting it into propulsion energy for the motor vehicle itself.

Therefore, object of the present invention is solving the above prior art problems, by providing an energy-recovering motor vehicle equipped with at least one turbine aimed to convert the air currents generated by the advancement motion of the motor vehicle itself into propulsion energy for such motor vehicle.

Another object of the present invention is providing an energy-recovering motor vehicle, in particular with electric or compressed air propulsion, in which the air current generated by the advancement motion of the vehicle is used to rotate the turbine connected to a electric energy generator or an air compressor to provide propulsion energy for such motor vehicle.

Moreover, an object of the present invention is providing an energy-recovering motor vehicle equipped with at least one turbine aimed to recover the remaining amount of thrusting energy of the motor vehicle and convert it into propulsion energy.

The above and other objects and advantages of the invention, as will appear from the following description, are obtained with an energy-recovering motor vehicle as claimed in claim 1. Preferred embodiments and non-trivial variations of the present invention are the subject matter of the dependent claims.

It will be immediately obvious that numerous variations and modifications (for example related to shape, sizes, arrangements and parts with equivalent functionality) can be made to what is described, without departing from the scope of the invention as appears from the enclosed claims.

The present invention will be better described by some preferred embodiments thereof, provided as a non-limiting example, with reference to the enclosed drawings, in which:

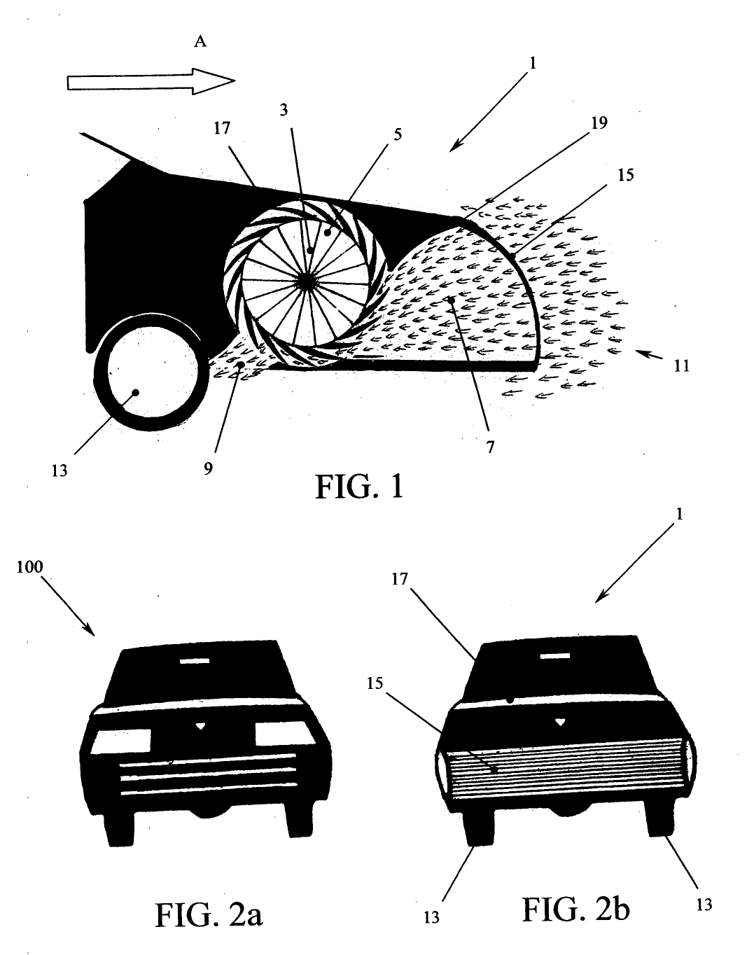

FIG. 1 shows a side sectional view of a preferred embodiment of the motor vehicle according to the present invention;

FIGS. 2a and 2b show front views respectively of a motor vehicle according to the prior art and of a preferred embodiment of the motor vehicle according to the present invention;

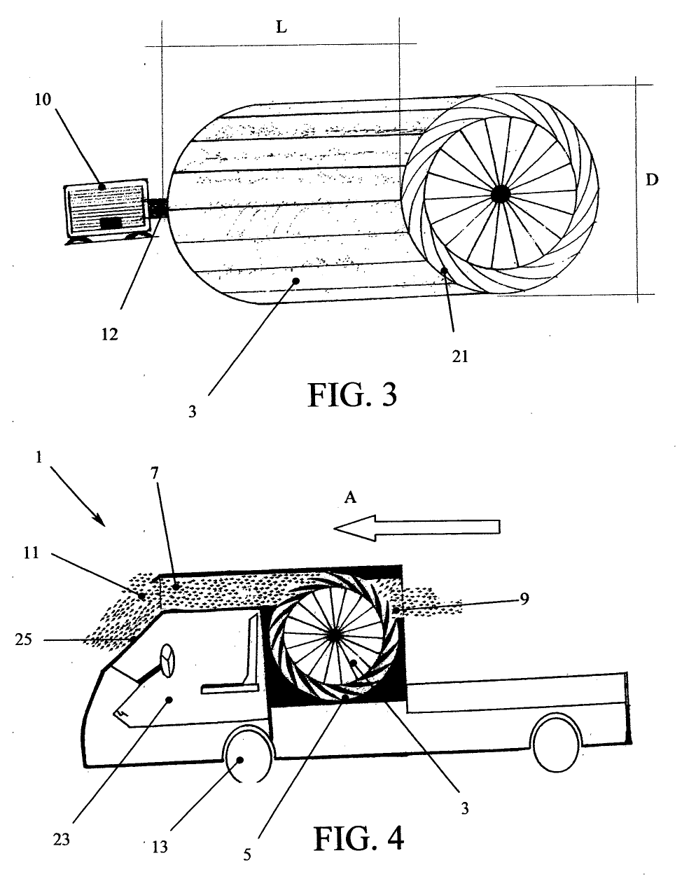

FIG. 3 shows a side perspective view of a component of the motor vehicle according to the present invention;

FIG. 4 shows a side sectional view of another preferred embodiment of the motor vehicle according to the present invention; and

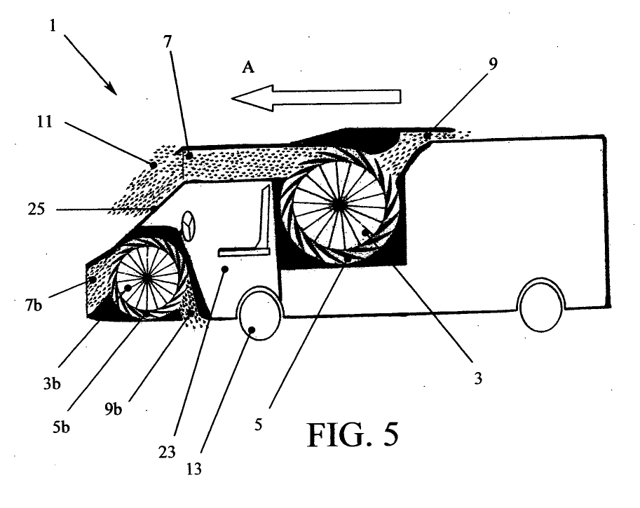

FIG. 5 shows a side sectional view of a further preferred embodiment of the motor vehicle according to the present invention.

With reference in particular to the Figures, it is possible to note that the energy-recovering motor vehicle 1 according to the present invention is equipped with at least one turbine 3 arranged inside a suitable space 5 inside the motor vehicle 1 itself, such space 5 communicating with the outside environment through at least one suction manifold 7 and at least one exhaust duct 9, such turbine 3 being rotated by at least one air current 11 generated by the advancement motion A of the motor vehicle 1 entering through such suction manifold 7 in order to touch and rotate the turbine 3 and going out through the exhaust duct 9, such turbine 3 being further connected to means 10 for converting the mechanical energy generated by the rotation of the turbine 3 itself into propulsion energy of the motor vehicle; the motor vehicle 1 further comprises means for storing and accumulating such propulsion energy and means for supplying such propulsion energy from the means for storing and accumulating to the propulsion means of the motor vehicle 1.

With particular reference to FIG. 1, it is possible to note that, in a preferred embodiment of the motor vehicle 1 according to the present invention, the front wheels 13 are slightly on the rear with respect to traditional vehicles, so that room is created for the space 5 housing the turbine 3. Obviously, the suction manifold 7 can be covered on the front part by at least one protecting mask 15 sized in order to allow accumulating the most amount of air current 11 possible and to route it towards the turbine 3. Moreover, the bonnet 17 of the motor vehicle 1 can be slightly lifted in its front part 19 to make a greater external aerodynamics and create more room for the height of the protecting mask 15.

In general, the motor vehicle 1 according to the present invention will be longer with respect to a similar, traditional motor vehicle, the increase in length however not generating any additional resistance to get to produce the percentage of the above mentioned thrusting energy: for such purpose, it can be noted, in FIGS. 2a and 2b, a comparison between the front outlines of a motor vehicle 100 according to the prior art (FIG. 2a) and a motor vehicle 1 according to the present invention (FIG. 2b). In fact, in the previously mentioned case in which the vehicles arrive at 80% of the kinetic energy keeping 20% of thrusting energy, whose sum is equal to the resistance of the air current presented by the front volume of the vehicles, it can be noted how in the motor vehicle 1 according to the present invention, having the same front volume of the traditional motor vehicle 100, in order to obtain the same energy balance, it is necessary to exploit a portion included between 40% and 45% of the mask 15 in order to make the air current enter into the turbine and produce 20% of the thrusting energy: in fact, it can be noted that the entrance of the air current does not create any additional resistance with respect to the traditional motor vehicle 100 since, in this latter one, air would anyway have been used to cool the fuel-type engine.

Preferably, if the motor vehicle 1 according to the present invention is of the electric propulsion type, obviously the propulsion energy will be electric energy, the converting means 10 will comprise at least one alternator connected to the rotation shaft 12 of the turbine 3 and the means for storing and accumulating will comprise at least one battery operatively connected to the converting means.

Alternatively, if the motor vehicle 1 according to the present invention is of the compressed air aeolian propulsion type, obviously the propulsion energy will be kinetic energy generated by the compressed air, the converting means 10 will comprise at least one air compressor connected to the rotation shaft 12 of the turbine 3 and the means for storing and accumulating will comprise at least one bottle operatively connected to the converting means in order to store the compressed air produced thereby; moreover, differently from the previous case of the motor vehicle 1 with electric propulsion, the turbine 3 can rotate without speed limits imposed by the compressor, and it is possible to always keep the air pressure high in order to provide greater power to the compressed air engine.

The means for supplying will then take care of providing the electric energy or the compressed air contained in the means for storing and accumulating to the propulsion means of the motor vehicle 1 according to the present invention.

With particular reference to FIG. 3, it is possible to note how the converting means 10, being either an air compressor or an alternator, must be compact enough in order to be able to elongate the turbine 3 at a maximum, and consequently elongate its own surface touched by the air current, and obtain the maximum efficiency. Preferably, the turbine 3 should have a width L included between 90% and 95% of the width of the motor vehicle 1 (about 150 cm) and a diameter D included between 90% and 95% of the height of the motor vehicle 1 itself (about 90 cm): obviously, the turbine 3 can be made of any material suitable for such purpose, such as, for example, aluminium or carbon fibre. Moreover, in order to facilitate the rotation of the turbine 3, even at medium and high speeds of the motor vehicle 1, the wings 21 of the turbine 3 are preferably arranged next to the diameter of the turbine 3 itself, in order to obtain more force when producing energy: the arrangement of the winds 21 further allows creating room for integrating the converting means 10.

With particular reference to FIG. 4, it is possible to note an alternative embodiment of the motor vehicle 1 according to the present invention as a commercial vehicle. In such case, the suction manifold 7 is arranged above the driving cabin 23 in order to exploit the vehicle aerodynamics to route the air current 11 towards the turbine 3 contained inside the space 5 arranged behind the cabin 23 itself. Given the common sizes of a commercial vehicle and its energy consumptions, in this case of a preferred embodiment of the motor vehicle 1 according to the present invention, it is possible to use a turbine 3 with bigger sizes in order to produce a greater amount of energy, the turbine 3 being able to be increases due to the arrangement of the space 5 behind the cabin 23. In addition, each one of the side edges of the windscreen 25 could be equipped with a suitable edged profile adapted to prevent air from being wasted laterally.

In addition, with particular reference to FIG. 5, it is possible to note an alternative embodiment of the motor vehicle 1 according to the present invention as a commercial vehicle that can be equipped, in addition to the first turbine 3 arranged like in the previously described embodiment of FIG. 4, with a second turbine 3b, and its related space 5b, suction manifold 7b and exhaust duct 9b, the second turbine 3b being preferably arranged next to the front engine room of the motor vehicle 1, as shown in FIG. 1 and as an integration of the first turbine, if this one is not enough to produce the necessary energy.

In conclusion, it is clear how the motor vehicle 1 according to the present invention further decreases the environmental impact of already existing compressed air and electric traction vehicles, increasing their energy efficiency. Obviously, in extra-urban routes with high and medium/high speed, more energy advantages are obtained, while in routes with lower speed, typically urban ones, by decreasing the kinetic energy, the efficiency of the motor vehicle 1 according to the present invention decreases, since the production of energy through the turbine 3 is minimum, and the propulsion energy must anyway be provided by one's own traditional energy source, for example with a recharge in one's house or in a supply station.

1. Energy-recovering motor vehicle (1) characterised in that it is equipped with at least one turbine (3; 3b) arranged inside a space (5; 5b) inside said motor vehicle (1), said space (5; 5b) communicating with an outside environment through at least one suction manifold (7; 7b) and at least one exhaust duct (9; 9b), said turbine (3; 3b) being rotated by at least one air current (11) generated by an advancement motion (A) of said motor vehicle (1) entering through said suction manifold (7; 7b) in order to touch and rotate said turbine (3; 3b) and going out through said exhaust duct (9; 9b), said turbine (3) being further connected to means (10) for converting mechanical energy generated by said rotation of said turbine (3; 3b) into propulsion energy for said motor vehicle (1).

2. Motor vehicle (1) according to claim 1, characterised in that it comprises means for storing and accumulating said propulsion energy and means for supplying said propulsion energy from said means for storing and accumulating to propulsion means of said motor vehicle (1).

3. Motor vehicle (1) according to claim 2, characterised in that said propulsion energy is electric energy, said converting means (10) comprise at least one alternator connected to a rotation shaft (12) of said turbine (3; 3b) and said means for storing and accumulating comprise at least one battery operatively connected to said converting means.

4. Motor vehicle (1) according to claim 2, characterised in that said propulsion energy is kinetic energy generated by compressed air, said converting means (10) comprise at least one air compressor connected to a rotation shaft (12) of said turbine (3; 3b) and said means for storing and accumulating comprise at least one bottle operatively connected to said converting means in order to store said compressed air produced thereby.

5. Motor vehicle (1) according to claim 2, characterised in that said turbine (3; 3b) has a width (L) included between 90% and 95% of a width of said motor vehicle (1) and a diameter (D) included between 90% and 95% of a height of said motor vehicle (1).

6. Motor vehicle (1) according to claim 2, characterised in that said suction manifold (7) is arranged above a driving cabin (23) and said space (5) is arranged behind said cabin (23).

7. Motor vehicle (1) according to claim 6, characterised in that each one of the side edges of a windscreen (25) is equipped with an edged profile.

8. Motor vehicle (1) according to claim 6, characterised in that it further comprises a second turbine 3(b) and its related space (5b), suction manifold (7b) and exhaust duct (9b), said second turbine (3b) being arranged next to a front engine room of said motor vehicle (1).
